(19) United States
(12) Patent Application Publication
(10) Pub. No.: US 2010/0115472 A1
(43) Pub. Date: May 6, 2010

(54) Method of Facilitating Browsing and Management of Multimedia Files with Data Structure thereof

(76) Inventors: Kun-Bin Lee, Taipei City (TW); Ching-Chieh Wang, Yilan County (TW)

Correspondence Address: NORTH AMERICA INTELLECTUAL PROPERTY CORPORATION, P.O. BOX 506, MERRIFIELD, VA, 22116, US

(21) Appl. No.: 12/261,067

(22) Filed: Oct. 30, 2008

(51) Int. Cl. G06F 3/048

(52) U.S. Cl. 715/854

(57) ABSTRACT

A method of browsing multimedia files having a plurality of attribute information. Each of the plurality of attribute information is utilized for indicating a corresponding characteristic of the multimedia files. The method comprises: providing a browser comprising a user interface having multi-level hierarchical menus, each menu comprising at least a menu icon representing a group of the multimedia files which certain attribute information of the group of multimedia files are the same, wherein each of the menu icon is able to initiate a next level menu, or to initiate playing a target multimedia file; and playing the target multimedia file if the menu icon for initiating playing the target multimedia file has been activated.

### BACKGROUND OF THE INVENTION

1. Field of the Invention

The invention relates to a method of facilitating browsing and management of multimedia files, and more particularly, to a method of facilitating browsing and management of multimedia files with a data structure having dynamic attributes.

2. Description of the Prior Art

A lot of browsing techniques are utilized on various portable electronic products, such as digital cameras, cell phones, or portable media players (PMP), e.g. MP3 players. Take a digital camera as an example. When a user takes a photograph of Mount Fuji with a digital camera, a conventional digital camera indexes the photograph by a timestamp, which indicates time information of taking the photograph, or indicates the sequence of taking the photograph. And the conventional digital camera stores the photograph into a memory in combinations with the time stamp index. At a later time, when the user would like to browse the photograph, he may execute a conventional browsing system to browse the photographs by searching the index, for example the index indicating the moment when he took the photograph of Mount Fuji. However, when the user cannot remember the exact moment that he took the photograph of Mount Fuji, it becomes difficult to review the photograph again since the moment of taking the photograph of Mount Fuji is a unique clue for him to find out the photograph. This indicates a fact that it is inconvenient for the user to review the photograph without any other information but the moment of taking the photograph.

Another method of browsing photographs may implement by transferring all the photographs stored in the memory to a personal computer, and categorizing the photographs according to both memory of the user and personal preferences of the user. However, categorizing these photographs according to memory and personal preferences alone may create a lot of work for the user, and sometimes it may also result in erroneous categorization of the photographs as well as erroneous browsing, where errors are generated from erroneous timestamps, locations, or other available information memorized by the user.

Please refer to FIG. 1, which is a diagram illustrating a conventional method of browsing and managing multimedia files. As shown in FIG. 1, a plurality of small-scale preview photographs are arranged in a 3 by 3 matrix, where said small-scale photograph is a smaller scale for previewing large-scale photograph. And a photograph, which is denoted as e.g. “pic 3” in FIG. 1, is temporarily selected through a cursor as a current observed photograph on a screen of an electronic device, such as a digital camera. After activating the temporarily marked small-scale preview photograph by pushing an activating button accordingly, a large-scale photograph is displayed and/ or a related audio file is played, as shown in FIG. 1. The file management as shown in FIG. 1 is conventionally processed in a manual manner, i.e. depending on human intuition, and therefore, may cause some erroneous arrangement of the photographs, and consequent misses in browsing the photographs.

### SUMMARY OF THE INVENTION

It is therefore one of the objectives of the invention to provide a method of browsing multimedia files having a plurality of attribute information. Each of the plurality of attribute information is utilized for indicating a corresponding characteristic of the multimedia files. The method comprises: providing a browser comprising a user interface having multi-level hierarchical menus, each menu comprising at least a menu icon representing a group of the multimedia files which certain attribute information of the group of multimedia files are the same, wherein each of the menu icon is able to initiate a next level menu, or to initiate playing a target multimedia file; and playing the target multimedia file if the menu icon for initiating playing the target multimedia file has been activated.

The invention also provides an electronic apparatus for browsing multimedia files having a plurality of attribute information. Each of the plurality of attribute information is utilized for indicating a corresponding characteristic of the multimedia files. The apparatus comprises a browser and an input device. The browser comprises a user interface having multi-level hierarchical menus. Each menu comprises at least a menu icon representing a group of the multimedia files which certain attribute information of the group of multimedia files are the same, wherein each of the menu icon is able to initiate a next level menu, or to initiate playing a target multimedia file. The input device selects a desired menu icon of the menus.

Moreover, the invention provides a method for managing multimedia files having a plurality of attribute information. Each of the plurality of attribute information is utilized for indicating a corresponding characteristic of the multimedia files. The method comprises: coping or deleting a specific multimedia file; wherein the specific multimedia file is selected according to the attribute information of the multimedia files.

The invention further provides a method for storing a multimedia file having a plurality of attribute information into an electronic apparatus. Each of the plurality of attribute information is utilized for indicating a corresponding characteristic of the multimedia files. The method comprises: generating a file directory according to the attribute information of the multimedia file; and storing the multimedia file into the file directory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional method of browsing and managing multimedia files;

FIG. 2, FIG. 3, and FIG. 4 respectively illustrate the OSD menus in the multi-level hierarchical structure;

FIG. 5 illustrates a sketch diagram of the structure of an exemplary three-level hierarchical OSD menu according to an embodiment of the invention;

FIG. 6 illustrates an embodiment of the invention with more than two interim OSD menus for facilitating browsing a target multimedia;

FIG. 7 shows lookup table for a metadata profile;

FIG. 8 and FIG. 9 illustrate an embodiment of the OSD menus, where FIG. 8 illustrates a first level OSD menu and FIG. 9 illustrates a second-level OSD menu.

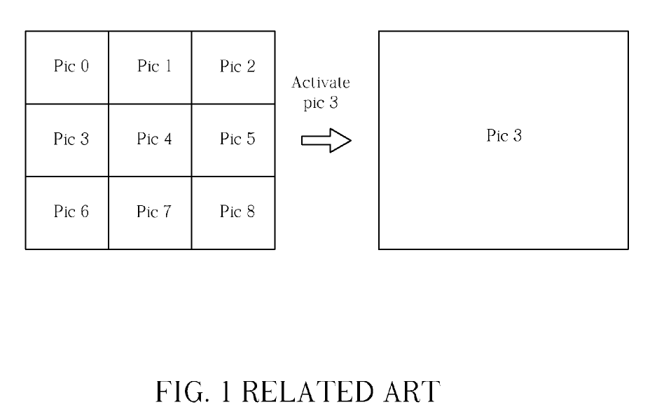

### DETAILED DESCRIPTION

Therefore, for facilitating a user to browse or to manage stored multimedia files, a data type called metadata is first provided. The metadata basically indicates related information of the multimedia file other than the data of the multimedia file itself, where said related information may be utilized for indexing or introducing said multimedia file in detail so as to make the multimedia file, for example, to be managed effectively. A primary characteristic of the metadata lies in flexibility to dynamically add, erase, and replace attributes of the metadata according to current requirements of the user.

In an embodiment of the invention, the metadata of a multimedia file may be established when the multimedia file is generated. Or, the metadata may be generated or modified after generating the multimedia file. The generated metadata may be stored into a header or a reserved section of the multimedia file, such as JPEG EXIF header. Or the metadata may be stored as a metadata file, and a linking-information is to be stored into the header or the reserved section of the multimedia file so as to link the multimedia file with the metadata file. The metadata of the multimedia file may include a plurality of attributes, each of the attributes may have one or more attribute information. The attribute information indicating related information of the multimedia file can be in a text format or in an audio format. Taking photographs as an example, the attributes of a photograph may include location-related attribute, climate-related attribute, time-related attribute, audio-related attribute and other attributes.

The location-related attribute is utilized to describe place information of taking the photograph. The location-related attribute information can be retrieved from a global positioning system (GPS), a local network or chamber information specified by the owner of the chamber. Based on information provided by the GPS, the local network or the chamber, the location-related attribute information could be a district, a country, a region, a city, a landmark, street name, a longitude and latitude data, height from the sea level, and/or room, space, floor of a building etc. The local network may be a wired or wireless communication channel, such as Bluetooth or USB.

The climate-related attribute is utilized to describe the weather information under which the photograph has been taken. The climate-related attribute information can be retrieved from the local network. Based on information provided by the local network, the climate-related attribute information could be temperature, rainfall, humidity, wind velocity, and/or wind direction.

The time-related attributes utilized to describe time information of taking the photograph. The time-related attribute information can be retrieved from the global positioning system, the local network, or system information of a digital camera for snapping the photograph. Based on information provided by the global positioning system, the local network or the system information, the time-related attribute information could be a season, a date, a moment (daytime or nighttime) and/or a timestamp.

The audio-related attribute may have audio-related attribute information which is utilized to indicate an ambient sound during snapping the photograph, or some voice or human speech added arbitrarily after taking the photograph.

The other attribute may have attribute information corresponding to a category of the photograph, for example a scene photo, or a passport size photo. Or, the attribute may have attribute information corresponding to a number of persons shown in the photograph. More particularly, the attribute may have attribute information corresponding to the name of the person who is shown in the photograph. In addition, a related link, such as a URL (Uniform Resource Locator), or reference information, like preference rating, may also be utilized as the attribute information.

Accordingly, each of the multimedia files respectively has a plurality of attribute information, for example Date (2006-July-03), City (Taipei) and landmark (Zoo), indicating related information of the multimedia file. In consequence, for the multimedia files generated at various time and location, the corresponding attribute information of the multimedia files may be varied. Therefore, according to the attribute information of the multimedia file, several applications for facilitating browsing and managing the multimedia files are described hereafter.

In one embodiment of the invention, an electronic device, such as a digital camera, generates file directories according to the metadata of the multimedia file, and thereby stores the multimedia file into corresponding file directory. When a photograph is snapped by the digital camera, the digital camera, according to required attributes, generates a plurality of attribute information related to the photograph. The attribute information of the photograph may include, for example, Date (2006-July-03), City (Taipei) and landmark (Zoo). For the sake of brevity, there is three attribute information listed as an example in this embodiment which do not intend to limit the scope of the invention but exemplify the invention. Then, the digital camera, according to the attribute information of the photograph, generates a file directory, such as “\2006-July-03\Taipei\Zoo\,” and thereby stores the multimedia file of the photograph into the file directory. In another embodiment, the file directory may include a directory-metadata having attribute information corresponding to that of the multimedia file stored in this directory.

When another new photograph is generated or is to be stored into the digital camera, the digital camera also generates a plurality of attribute information related to the new photograph. For the new photograph, the plurality of attribute information is, for example, Date (2006-July-03), City (Taipei) and landmark (101 Tower). According to an embodiment of the invention, the digital camera checks the directory-metadata of all existent file directories to identify a specific file directory to store the multimedia file of the new photograph. If the directory-metadata of one file directory, e.g. “\2006-July-03\Taipei\101 Tower\,” matches with that of the new photograph, the digital camera stores the multimedia file of the new photograph into the identified specific file directory.

If the attribute information of the new photograph does not match with any directory-metadata of existent file directories, the digital camera then generates a new file directory and stores the multimedia file of the new photograph into the new generated file directory. For example, a photograph having attribute information like Date (2006-July-13) and City (Tokyo) may be stored into a new file directory “\2006-July-13\Tokyo\.”

In another embodiment, the digital camera may firstly check the directory-metadata of the latest generated file directory to determine the specific file directory for storing the new multimedia file. In case if the specific file directory does not existing, the digital camera will generate a new file directory, and will store the new multimedia file in the new file directory.

In another embodiment of the invention, an electronic device, such as a digital camera, generates a metadata profile for storing corresponding metadata of multimedia files. The metadata profile includes at least one of attribute information for each of the multimedia files. In addition, the metadata profile may store the related directory—metadata which indicates the file directory for storing the multimedia files. The profile may be a lookup table or a database.

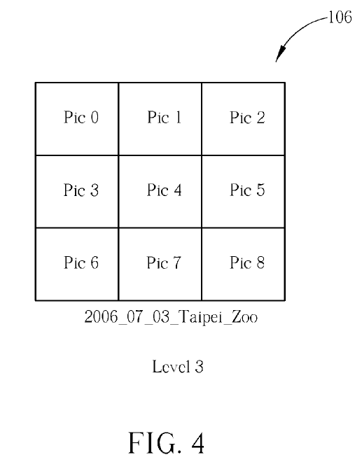

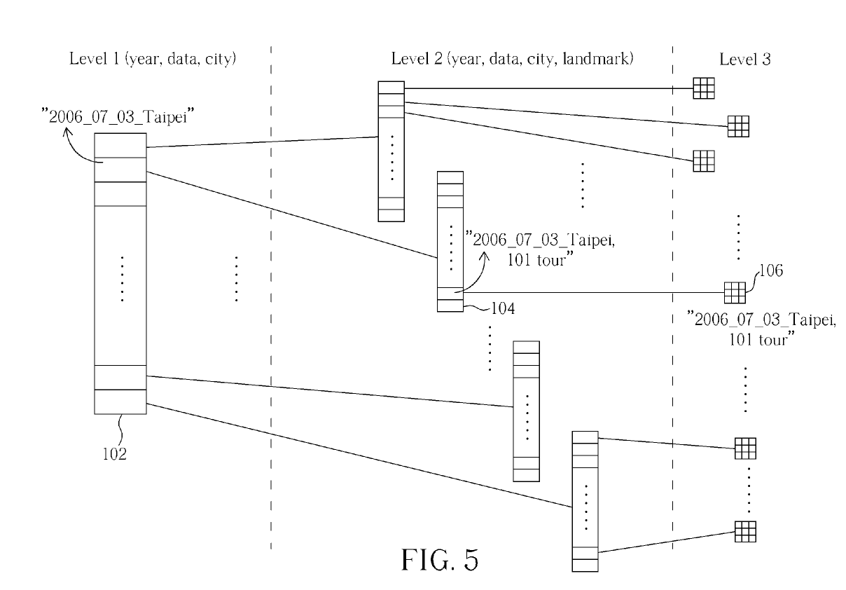

According to an embodiment of the invention, a browser of an electronic apparatus, such as a digital camera or a digital frame, has a user interface with multi-level hierarchical on-screen display (OSD) menus for facilitating browsing the multimedia files stored in the electronic device. FIG. 5 illustrates a sketch diagram of the structure of an exemplary three-level hierarchical OSD menu according to an embodiment of the invention. The multimedia files stored in the electronic apparatus are capable of categorizing into various groups according to the attribute information. The OSD menu is designed to show a plurality of menu icons. Each of the menu icons represents a group of the multimedia files which certain of attribute information of the group of multimedia files are the same. And each of the menu icons is able to be selected by a user. The selection operation may be completed through pushing an “Enter” key on a corresponding user interface after a cursor has been pointed at said selected menu icon, or by touching said selected menu icon on a touch screen.

If a menu icon is selected, the browser may pop out a next level OSD menu or a target multimedia file. The menu icon presented on the OSD menu, for example, could be a predefined icon, a representing small-scale picture, texts of the attribute information, or in combination of above listed features. The electronic apparatus may select a specific multimedia file from the group of multimedia files to be the representing small-scale picture according to a predefined rule, like the earliest picture, or selected by the user. In another embodiment the user interface of the electronic apparatus could implemented with a plurality of physical button menus. Each button menus represents a group of the multimedia files which certain of attribute information of the group of multimedia files are the same. Furthermore, the functionality of each physical button is programmable. For example, each menu can represent different group of the multimedia files at different level of the menu.

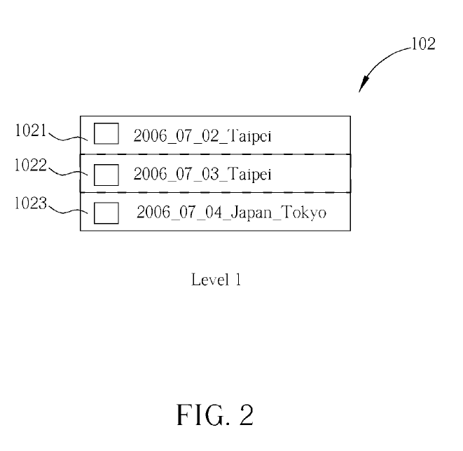

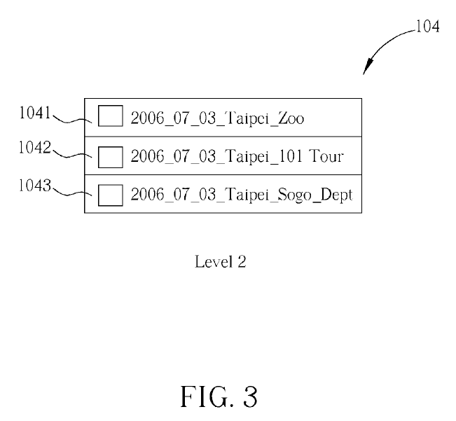

Please refer to FIG. 2, FIG. 3, and FIG. 4, which respectively illustrate the OSD menus in the multi-level hierarchical structure, whereas FIG. 2 indicates a first level OSD menu 102 denoted as Level 1, FIG. 3 indicates a second level OSD menu 104 denoted as Level 2, and FIG. 4 indicates a third level OSD menu 106 denoted as Level 3. As shown in FIG. 2, the first level OSD menu 102 has 3 menu icons 1021, 1022, 1023. Each of the menu icons 1021, 1022, 1023 includes a representing small-scale picture and texts of attribute information. And each of the menu icons 1021, 1022, 1023 respectively represents a group of multimedia files having the same date attribute information and city attribute information.

FIG. 3 illustrates a second level OSD menu 102. The second level OSD menu 104 has 3 menu icons 1041, 1042, 1043. Each of the menu icons 1041, 1042, 1043 includes a representing small-scale picture and texts of attribute information. Each of the menu icons presented on the second level OSD menu 104 respectively represents a group of multimedia files which have the same date attribute information, city attribute information and landmark attribute information.

And FIG. 4 illustrates a third level OSD menu 106. The third level OSD menu 106 has 9 menu icons. Each of the menu icons of the third level OSD menu 106 respectively presents a preview picture of a target multimedia file.

When a user browses the multimedia files in the electronic apparatus, the first OSD menu 102 is provided first. After the user activates a selected menu icon in the first level OSD menu 102, for instance menu icon 1022, the corresponding second level OSD menu 104 shown in FIG. 3 is initiated. Each of the menu icons 1041, 1042, 1043 presented on the popped out second level OSD menu 104 represents a group of multimedia files having the same “Date” and “City” attribute information. However, the groups of multimedia files respectively represented by menu icons 1041, 1042, 1043 have various “Landmark” attribute information. The menu icon 1041 represents a group of multimedia files having attribute information like Date (2006-July-3), City (Taipei) and Landmark (Zoo). The menu icon 1042 represents a group of multimedia files having attribute information like Date (2006-July-3), City (Taipei) and Landmark (101 Tower). And the menu icon 1043 represents a group of multimedia files having attribute information like Date (2006-July-3), City (Taipei) and Landmark (SOGO department store).

After the user activates a selected menu icon in the second level OSD menu 104, for instance the menu icon 1041, the corresponding third level menu 106 shown in FIG. 4 is initiated. In third level OSD menu 106, preview pictures corresponding to the multimedia files having attribute information Date (2006-July-3), City (Taipei) and Landmark (Zoo) are presented and are arranged as a 3 by 3 matrix, which is merely an exemplary embodiment of the third level menu 106. The preview picture is displayed in a reduced scale.

As shown in FIG. 4, preview pictures corresponding to the multimedia files which were generated at Zoo of Taipei on 2006/07/03 are presented on the third level OSD menu so that the user may immediately recognize primary characteristics of a target photograph through the preview pictures. Then after the user activates a selected preview picture in the third level OSD menu 106, for instance the preview picture “Pic.3”, the corresponding target photograph is displayed.

Moreover, an audio file related to the photograph “Pic. 3,” which stored as a metadata, may also be played when said preview picture “pic 3” is selected for recollecting important information for the user.

A video file, a text metadata or other information may also be utilized and generated in the same manner with the abovementioned audio file.

A usage property of the metadata is that attribute information utilized for indicating the searched multimedia file through OSD menus shown in FIG. 2 to FIG. 4 may be increased, eliminated or modified dynamically according to requirements of the user. For example, the attribute information Date (2006-July-3), City (Taipei) and Landmark (Zoo) displayed along with the preview photograph “pic 3” may be extended to include attribute information Date (2006-July-3), Time (01:40OM), City (Taipei), Landmark (Zoo) and owner (Simon).

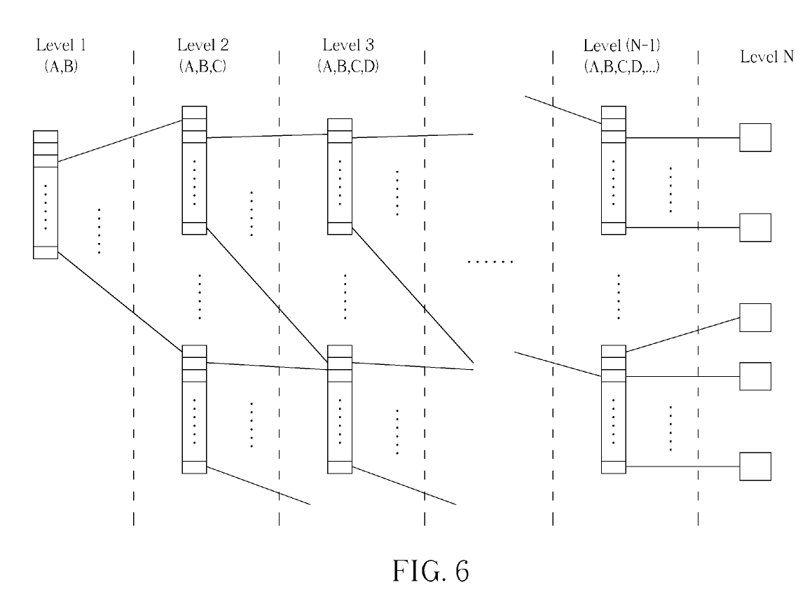

Note that in FIG. 2 and FIG. 3, both Level 1 and Level 2 OSD menus are merely interim OSD menus in the abovementioned embodiment for searching a target photograph from the preview pictures in Level 3 OSD menu. There may be more than two interim OSD menus could be implemented for browsing the target photograph. In other words, another interim OSD menu may also be incorporated in the embodiment shown in FIG. 2, FIG. 3, and FIG. 4 for displaying other menu icon representing a group of multimedia files having same attribute information. FIG. 6 illustrates an embodiment of the invention with more than two interim OSD menus for facilitating browsing a target multimedia.

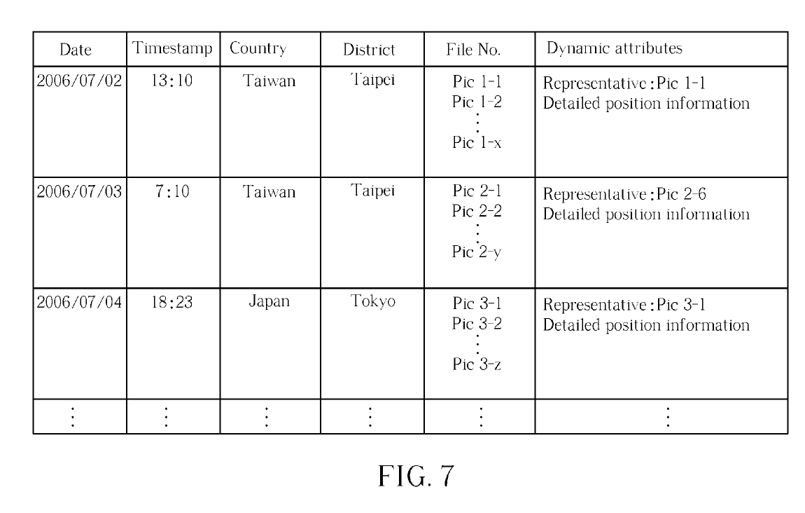

FIG. 7 shows a lookup table according to another embodiment of the invention for a metadata profile. The lookup table collects a plurality of attribute information of multimedia files. All the attribute information could be recorded into the lookup table. When a user browses the multimedia files, the multi-level hierarchical OSD menus are provided according to the attribute information stored in the lookup table. Note that the attribute information illustrated in FIG. 7 are merely exemplary for the invention, and that any replacement, increase, modification or decrease of the illustrated attribute information in FIG. 7 are not intended to be a limitation of the invention. It also indicates the fact that the user may dynamically edit or change attributes in the lookup table for a specific requirement. And thereby facilitating the electronic apparatus generates menu icons for each OSD menus with the aid of the lookup table. Note that other types of available lookup tables or data structure may be implemented as a metadata profile.

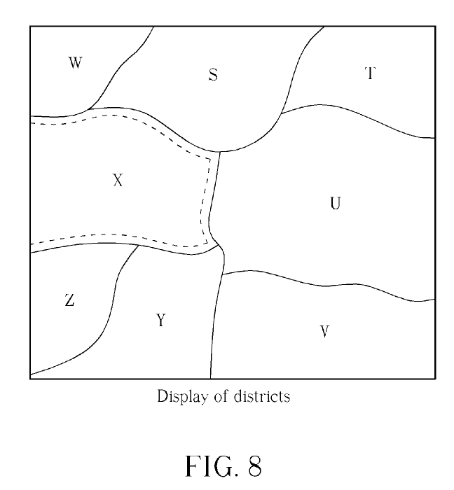

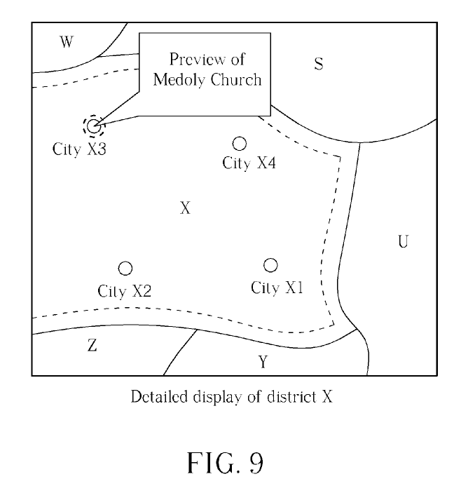

FIG. 8 and FIG. 9 illustrate another related embodiment of the OSD menus. FIG. 8 illustrates a first level OSD menu and FIG. 9 illustrates a second level OSD menu. In FIG. 8, a first level OSD menu is incorporated with a 2D or 3D geographic map, where the map is displayed on a screen of an electronic apparatus. The 3D geographic map, for example, may be an interior drawing showing information about rooms, space and floors. Furthermore, the 3D geographic map may be a contour map showing information like contour or geoids.

In FIG. 9, a second level OSD menu is also incorporated with a zoom-in geographic map. Photographs stored in the electronic apparatus are primarily attributed according to locations of where the photograph is taken. In FIG. 8, districts illustrated on the map are regarded as menu icons of the first level OSD menus. Since there are several cities in a district, cities of a certain district are listed as menu icons of the second level OSD menus in FIG. 9. For example, a photograph taken at the Melody Church located in a city X3 of a district X is categorized according to attribute information of District (X) and City (X3). When a user wants to look up the photograph “District X, City X3, Melody Church”, he first browses the first level OSD menu to search for the menu icon indicating the District X, and activates the searched menu icon, i.e. District X, for browsing cities of the District X and entering into the second level OSD menu. In the second level OSD menu, as shown in FIG. 9, a zoom-in map of the District X may be displayed. And the user browses the second level OSD menu to search for a menu icon indicating the city X3 in said second level OSD menu, and activates the searched menu icon, i.e. the city X3, for browsing a further level OSD menu which is related to other attribute information, such as churches or landmarks in the city X3, or for directly displaying the photograph or playing the audio file having attribute information District (X), City (X3), Landmark (Melody Church).

Note that the maps incorporated with the first level OSD menu and the second level OSD menu illustrated respectively in FIG. 8 and FIG. 9 may be directly retrieved from a global positioning system through a local wireless network or a global wireless network. Besides, the maps may belong to software or an application program installed in and executed by the electronic apparatus.

The multimedia files stored in the electronic apparatus may be copied or deleted. According to an embodiment of the invention, the user may copy or delete a plurality of multimedia files according to the metadata. In other word, for example, the user is able to copy or delete the multimedia files according to the attribute information of preference rating. So, with the assistance of attribute information, a user could copy multimedia files with high preference rating into a specific file directory or a specific storage device, and could delete multimedia files with lower preference rating from the electronic apparatus.

The electronic apparatus mentioned above for applying the method of the invention may be a portable electronic apparatus, such as a personal digital assistant, a digital camera, a portable MP3 player, or a cell phone. The multimedia file browsed and managed in the invention may be a photograph, an audio file, a video file, or a multimedia stream file.

In the method of the invention, with the metadata and its dynamic attributes, a user is free to manage multimedia files so that he can easily browse the multimedia files. Moreover, a user can easily store the multimedia files into various logical or physical file directories or storage spaces in the assistance of those attribute information. Therefore, flexibility in managing attribute information while managing and browsing multimedia files is improved and more advanced than the conventional method. The invention leads to a more efficient way for the user to setup rules for managing and browsing multimedia files in the electronic apparatus.

Those skilled in the art will readily observe that numerous modifications and alterations of the device and method may be made while retaining the teachings of the invention.

What is claimed is:

1. A method of browsing multimedia files having a plurality of attribute information, wherein each of the plurality of attribute information is utilized for indicating a corresponding characteristic of the multimedia files, the method comprising:
providing a browser comprising a user interface having multi-level hierarchical menus, each menu comprising at least a menu icon representing a group of the multimedia files which certain attribute information of the group of multimedia files are the same, wherein each of the menu icon is able to initiate a next level menu, or to initiate playing a target multimedia file; and
playing the target multimedia file if the menu icon for initiating playing the target multimedia file has been activated;
wherein the attribute information may be modified, increased or eliminated dynamically according to requirements of a user.

2. The method as claimed in claim 1 wherein the plurality of attribute information comprises attribute information selected form a group consisting of time-related attribute information, location-related attribute information, climate-related attribute information, audio-related attribute information, information corresponding to how many persons shown in the photograph, attribute information corresponding to the name of the person who is shown in the photograph, related-link information, and reference information;
wherein the location-related attribute information corresponds to a place of generating the multimedia file;
wherein the climate-related attribute information corresponds to the weather under which the multimedia file has been generated;
wherein the time-related corresponds to when the multimedia file has been generated.

3. The method as claimed in claim 2 wherein the attribute information may be retrieved from a global positioning system, a local network or system information.

4. The method as claimed in claim 2 wherein the location-related attribute information comprises attribute information selected from a group consisting of a district, a country, a region, a city, a landmark, longitude and latitude data, and a street name.

5. The method as claimed in claim 2 wherein the climate-related attribute information comprises attribute information selected from a group consisting of temperature, rainfall, humidity, wind velocity, and a wind direction corresponding to the weather under which the multimedia file has been generated.

6. The method as claimed in claim 2 wherein the time-related attribute information comprises attribute information selected from a group consisting of a season, a date, a moment or a timestamp corresponding to when the multimedia file is generated.

7. The method as claimed in claim 1 wherein the menu is able to be displayed incorporated with a geographic map.

8. The method as claimed in claim 1 wherein the method further comprising:
displaying the next level menu if the menu icon for initiating the next level menu has been activated.

9. The method as claimed in claim 1 wherein the attribute information is in a text format or in a multimedia format.

10. The method as claimed in claim 1 further comprising:
providing a media content profile or a database for recording the attribute information of the multimedia files.

11. The method as claimed in claim 10, wherein the media content profile records a directory-metadata indicating the file directory which stores the multimedia files.

12. An electronic apparatus for browsing multimedia files having a plurality of attribute information, wherein each of the plurality of attribute information is utilized for indicating a corresponding characteristic of the multimedia files, the apparatus comprising:
a browser comprising a user interface having multi-level hierarchical menus, each menu comprising at least a menu icon representing a group of the multimedia files which certain attribute information of the group of multimedia files are the same, wherein each of the menu icon is able to initiate a next level menu, or to initiate playing a target multimedia file; and
an input device for selecting a desired menu icon of the menus.

13. A method for managing multimedia files having a plurality of attribute information, wherein each of the plurality of attribute information is utilized for indicating a corresponding characteristic of the multimedia files, the method comprising
coping or deleting a specific multimedia file;
wherein the specific multimedia file is selected according to the attribute information of the multimedia files.

14. The method as claimed in claim 13, wherein the plurality of attribute information comprises attribute information selected form a group consisting of time-related attribute information, location-related attribute information, climate-related attribute information, audio-related attribute information, information corresponding to how many persons shown in the photograph, attribute information corresponding to the name of the person who is shown in the photograph, related-link information, and reference information;
wherein the location-related attribute information corresponds to a place of generating the multimedia file;
wherein the climate-related attribute information corresponds to the weather under which the multimedia file has been generated;
wherein the time-related corresponds to when the multimedia file has been generated.

15. The method as claimed in claim 14 wherein the attribute information may be retrieved from a global positioning system, a local network or system information; wherein the attribute information may be modified, increased or eliminated dynamically according to requirements of a user.

16. A method for storing a multimedia file having a plurality of attribute information into an electronic apparatus, wherein each of the plurality of attribute information is utilized for indicating a corresponding characteristic of the multimedia files, the method comprising:
generating a file directory according to the attribute information of the multimedia file; and
storing the multimedia file into the file directory.

17. The method as claimed in claim 16 further comprising:
generating a directory-metadata having attribute information corresponding to that of the multimedia file stored in this directory.

18. The method as claimed in claim 17 further comprising:
checking the attribute information of an existent file directory when a new multimedia file is to be stored into the electronic apparatus; and
generating a new file directory according to the attribute information of the new multimedia file if the attribute information of the new multimedia file does not match the attribute information of the existent file directory.

19. The method as claimed in claim 17 further comprising:
checking the attribute information of a latest generated file directory when a new multimedia file is to be stored; and
generating a new file directory according to the attribute information of the new multimedia file if the attribute information of the new multimedia file does not match the attribute information corresponding to the latest generated file directory.

20. The method as claimed in claim 16, wherein the attribute information of the multimedia files comprises attribute information selected form a group consisting of time-related attribute information, location-related attribute information, climate-related attribute information, audio-related attribute information, information corresponding to how many persons shown in the photograph, attribute information corresponding to the name of the person who is shown in the photograph, related-link information, and reference information.

21. The method as claimed in claim 16, wherein a file directory name of the generated file directory comprises the attribute information.

22. A method of browsing multimedia files having a name related attribute information, wherein the name related attribute information is utilized for indicating name of the person who is shown in the photograph, the method comprising:
providing a browser comprising a user interface having a menu, the menu comprising at least a menu icon representing a group of the multimedia files comprising the same name related attribute information, wherein each of the menu icon is able to initiate playing a target multimedia file; and
playing the target multimedia file if the menu icon has been activated.

23. An electronic apparatus for storing a multimedia content profile with a data structure comprising a plurality of attribute information, wherein each of the plurality of attribute information is utilized for indicating a corresponding characteristic of a multimedia file.

24. The electronic apparatus as claimed in claim 23, wherein the electronic apparatus further comprises a file directory for storing the multimedia file; wherein the file directory comprises a directory-metadata; wherein the multimedia content profile further comprises the directory-metadata for indicating the file directory which stores the multimedia file.

25. The electronic apparatus as claimed in claim 23, wherein the attribute information of the multimedia files comprises attribute information selected form a group consisting of time-related attribute information, location-related attribute information, climate-related attribute information, audio-related attribute information, information corresponding to how many persons shown in the photograph, attribute information corresponding to the name of the person who is shown in the photograph, related-link information, and reference information.
